(19) United States
(12) Patent Application Publication
(10) Pub. No.: US 2009/0269168 A1
(43) Pub. Date: Oct. 29, 2009

(54) BOOKBINDING SYSTEM USING ADHESIVE

(75) Inventor: Yoshio Oyama, Tokyo (JP)

Correspondence Address: KATTEN MUCHIN ROSENMAN LLP, 575 MADISON AVENUE, NEW YORK, NY, 10022-2585, US

(73) Assignee: SANYO ARCH CO., LTD., Tokyo (JP)

(21) Appl. No.: 12/440,079

(22) PCT Filed: Sep. 28, 2006
(86) PCT No.: PCT/JP2006/319319

§ 371 Date: Apr. 16, 2009

(30) Foreign Application Priority Data
Sep. 11, 2006 (JP) 2006-245583

(51) Int. Cl. B42C 9/00

(52) U.S. Cl. 412/37

(57) ABSTRACT

A novel bookbinding system, and bookbinding method, solving various problems attributed to the use of stapler needle. This is provided a bookbinding system, and bookbinding method, comprising, with respect to a book produced through application of an adhesive to printed sheets, sheet folding and cutting, making perforations for adhesive penetration along a fold line on the stitch side thereof, carrying out adhesive application on a line or in a broken line, and performing sheet folding and stitching.

### TECHNICAL FIELD

The present invention relates to a bookbinding system using an adhesive, and more particularly relates to a bookbinding system which does not use a needle of a Hotchkiss or a stapler (simply referred to as a “stapler” in the document of the present application) in saddle stitching.

### BACKGROUND ART

Depending on binding methods, bookbinding is generally classified as follows.

(1) wire stitching
(i) thread sewing
(ii) wire stitching (wire side stitching, wire saddle stitching)

(2) adhesive binding
(i) notch binding
(ii) general adhesive binding

In a stitch structure of thread sewing, as shown in FIG. 10A, gathered pull out folders are mutually bound by thread sewing. In general, this thread sewing is carried out by machine sewing so that, when gathered pull out folders are placed on a saddle stitching conveyor of a stitching machine in the sequential order of a first fold of the beginning to a second fold while a center of each fold is being opened, the gathered pull out folders are automatically fed to the stitching machine and thereby processed by thread-sewing. After that, the gathered pull out folders are compressed and smoothened across the back portion such that they may become the same height as those of other portions, temporarily glued, the three sides thereof are cut, a back lining or the like is bonded to the back of a book by applying glue to the back, a casing-in work of a cover is finally carried out and thereby bookbinding is completed. A thread-sewing stitching structure is used for a case bound (case bound) of high quality and paperbacks (Paper Backs).

Adhesive binding is binding to bond the back of a fold section by only an adhesive, and it is classified as notch binding and general adhesive binding. As shown in FIG. 10B, in the notch binding, stitches of cut and uncut of approximately 15 mm:5 mm are formed on the back of a fold section at the paper folding stage in order to facilitate penetration of an adhesive and a folding process is carried out. As shown in FIG. 10C, in the general adhesive binding, the back portion of the content of one gathered book is treated by milling cut with a width ranging of from 2.5 to 3 mm and separated at the unit of one page.

In the adhesive binding, after that, a hot melt type adhesive is applied to the back portion, a cover is wrapped and bookbinding is completed. The adhesive binding is for use with mainly case bounds, paperbacks, small-sized paperbacks, monthly magazines and so on.

As shown in FIG. 10D, a wire stitching is a method by which bookbinding is completed by binding gathered pull out folders (containing a cover portion) at the center of a book with only wires (e.g. stapler needles) without using adhesive. A wire stitching is classified as side stitching and saddle stitching depending on wire stitching methods. This wire stitching is an economical bookbinding method which consumes a little time for preparation and which can reduce a working time. This method is mainly for use in weekly magazines, information magazines, pamphlets (brochures), catalogs and the like with low cost and high productivity.

The present invention is intended to bind books such as weekly magazines, information magazines, pamphlets and catalogs with low cost and high productivity which are to be treated by “saddle stitching”.

As described above, when a book with relatively lesser pages such as picture books, magazines, pamphlets, brochures and the like (e.g. book with pages less than 30 odd pages) is bound, in general, a text and a cover are gathered together, treated by saddle stitching with wires (e.g. stapler needles) along a center folding and other three sides are trimmed.

It should be noted that the inventor of the present invention has no information of patent documents or non-patent documents disclosing a bookbinding system which does not use a needle such as a needle of a stapler in saddle stitching, which will be described later on, but which uses an adhesive.

### DISCLOSURE OF INVENTION

### Problems to be Solved by the Invention

Wires such as stapler needles (hereinafter simply referred to as “stapler needles”) for use in saddle stitching of bookbinding are made of metal and cause various problems. For example, since stapler needles are pressed into a book along a crease lying between a gathered text and a cover, a tip end portion of a stapler needle is sharp inevitably. Accordingly, during reading, readers have been frequently experienced that they are injured at the finger by the sharp tip end of the bound stapler needle.

From a viewpoint of recycling resources, it is important to reuse (recycle) papers after books were used. However, since a stapler needle is made of metal, when papers are dissolved by a proper solution, a needle is not dissolved but left as it is. Unless a remaining stapler needle is removed separately by a proper method, it is not possible to recycle dissolved paper portions as recycled papers. A removed stapler needle is made of metal and hence it is cumbersome to treat it.

Further, since the stapler needle is made of metal, when books are fired after they were used, the stapler needle may not be fired and left as it is. A remaining stapler needle has to be separately treated by proper methods and it is cumbersome to treat the stapler needle because it is made of metal.

Further, in the case of an explanatory brochure such as an instruction book attached to foods and drinks such as those that directly affect the human body, if a stapler needle is got out of the instruction book and so on and mixed into foods and a user inadvertently swallows it, then the thus swallowed stapler needle would become very dangerous for the human body.

Further, if a stapler needle is used for picture books intended for little child and child and brochures such as instruction books for toys, then when a child puts a brochure into his or her mouth and sucks it, a paper portion of the brochure is melted so that the stapler needle is got out of the brochure, there is a risk that the child will swallow the stapler needle inadvertently.

From these standpoints of various factors such as safety to the human body, recycling of resources, safety to the environments and risks exerted to little child and child, a stapler needle for use with saddle stitching in bookbinding has various problems to be solved.

### Means for Solving the Problem

Under the above-described situation, the inventor of the present application aims to improve convenience in recycling resources, to improve safety to the environments and to remove risks exerted to little child and child by removing the use of a stapler needle in saddle stitching of bookbinding.

Accordingly, it is an object of the present invention to provide a novel bookbinding system that is able to solve various problems caused by the use of a stapler needle.

Further, it is an object of the present invention to provide a novel bookbinding method that is able to solve various problems caused by the use of a stapler needle.

In order to attain the above-described objects, a book according to the present invention may be a book produced through application of an adhesive to a printed paper, paper folding and cutting, in which an adhesive is applied to the printed paper in a line along a folded line on the stitch side.

Further, a book according to the present invention is a book produced through application of an adhesive to a printed paper, paper folding and cutting, in which an adhesive is applied to the printed paper in dots formed at a constant interval along a folded line on the stitch side.

Further, in the above-described book, the adhesive may keep a spherical shape by using surface tension until paper folding is carried out.

Further, a book according to the present invention is a book produced through application of an adhesive to a printed paper, paper folding and cutting, having perforations for adhesive penetration along a folded line on the stitch side thereof from one side, carrying out adhesive application in a line or in dots formed at a constant interval along a folded line on the stitch side from one side of the paper whereby the adhesive penetrates the perforations to be stitched.

Further, a book according to the present invention is a book produced through application of an adhesive to a printed paper, paper folding and cutting, having perforations for adhesive penetration along a folded line on the stitch side thereof, carrying out adhesive application in a line or in dots formed at a constant interval along a fold line on the stitch side from both sides of the paper whereby the adhesive penetrates the perforations to be stitched.

Further, in the above-described book, one or more than two shapes for the adhesive penetration perforations may be selected from a group including circular, elliptical, square and hexagonal holes and a broken-line.

Further, in the above-described book, the adhesive penetration perforations may be formed not only on an adhesive application area but also formed along a folded line on the stitch side.

Further, in the above-described book, the adhesive applied to the printed paper along the folded line on the stitch side may be applied to the folded line beyond a finishing line on the printed paper.

Further, in the above-described book, the printed paper may be a white ground which is not printed along a fold line on the above-described stitch side on which the above-described adhesive application area is located.

Further, a bookbinding method according to the present invention for applying an adhesive to a printed paper and folding the printed paper is a bookbinding method in which an adhesive is applied to the printed paper along the folded line of the stitch side in a line and in which the printed paper is folded.

Further, a bookbinding method according to the present invention for applying an adhesive to a printed paper and folding the printed paper is a bookbinding method in which an adhesive is applied to the printed paper along the folded line of the stitch side in a short line and in which the printed paper is folded.

Further, in the above-described bookbinding method, the folding may be carried out in a state that the adhesive applied to the printed paper in a short line keeps a spherical shape by using surface tension.

Further, in the above-described bookbinding method, adhesive penetration perforations may be formed on the paper along the folded line of the stitch side and the adhesive may be applied to the printed paper along the folded line of the stitch side from one side of the paper in a line or in dots formed at a constant interval to thereby bind a book.

Further, in the above-described bookbinding method, adhesive penetration perforations may be formed on the paper along the folded line of the stitch side and the adhesive may be applied to the printed paper along the folded line of the stitch side from both sides of the paper in a line or in dots formed at a constant interval to thereby bind a book.

Further, an adhesive application apparatus according to the present invention is an adhesive application apparatus in which a quantity of adhesive applied to the above-described book can be varied at every adhesive application area.

### EFFECT OF THE INVENTION

According to the present invention, it is possible to provide a novel bookbinding system which is able to solve various problems attributed to use of a stapler needle.

Further, according to the present invention, it is possible to provide a novel bookbinding method which is able to solve various problems attributed to use of a stapler needle.

### BRIEF DESCRIPTION OF DRAWINGS

FIG. 1 is a diagram showing a brochure which is described in this description.

FIG. 2A is a diagram showing the surface of a printed paper of the brochure shown in FIG. 1.

FIG. 2B is a diagram showing the back of this printed paper.

FIG. 2C is a diagram showing the state of the brochure obtained after paper folding.

FIG. 3A is a diagram to explain states occurred in dot-system adhesive application.

FIG. 3B is a diagram to explain a dot-system adhesive application that uses dot-system surface tension using surface tension.

FIG. 4 is a diagram to explain a dot-system or line-system adhesive application carried out after adhesive penetration perforations are formed in the adhesive application.

FIG. 5 is a diagram to explain a dot-system or a line-system to apply an adhesive to a printed paper from both surfaces after adhesive penetration perforations are formed in the adhesive application.

FIG. 6 is an enlarged view of the diagrams shown in FIGS. 2A and 2B and shows lines on the sheets cut at a final cutting and processing process as finishing lines;

FIG. 7 is a diagram showing an embodiment of an entire bookbinding and cutting system using an adhesive according to the present invention.

FIG. 8A is a diagram showing a controller and a cold glue pressure tank for use in the adhesive application.

FIG. 8B is a diagram to explain a situation of the adhesive application.

FIG. 8C is a diagram showing an example of an application gun used in the adhesive application.

FIG. 9 is a diagram to explain a principle of a high-speed automatic paper folding machine for use in paper folding.

FIG. 10A is a diagram to explain a thread sewing stitching structure according to a related art.

FIG. 10B is a diagram to explain a notch binding structure according to a related art.

FIG. 10C is a diagram to explain a general adhesive binding structure according to a related art.

FIG. 10D is a diagram to explain a wire binding structure according to a related art.

### EXPLANATIONS OF REFERENCE NUMERALS

1: brochure, 2: paper, printed paper, 4, 6, 8: adhesive application area, 9: finishing line, 10, 10-a, 10-b, 10-c, 10-d: adhesive, 12: adhesive penetration perforation, 18a, 18b: pressure tank, 21a, 21b, 21c: application gun, 16, 16-a, 16-b, 16-c: paper folding machine

### BEST MODE FOR CARRYING OUT THE INVENTION

Embodiments of a bookbinding system using an adhesive according to the present invention will be described below in detail with reference to the attached drawings. It should be noted that elements identical to those in the sheets of the drawings are denoted by identical reference numerals and an overlapping explanation will be omitted.

In the following explanation, bookbinding terms will be used as follows.

An “imposition” will be referred to as a work for bonding papers in accordance with size of a paper to be printed by a printing machine. The colophon will also be referred to as a work for bonding block copies in a similar manner.

A “bookbinding” will be referred to as a work for gathering printed papers in sequential order and for bonding the printed papers so that readers can readily read the printed papers.

A “gathering” will be referred to as a work for arranging fold sections in sequential order of pages and for arranging fold sections as a book. Also, the □gathering□will be referred to as a work for arranging a series of papers.

A “cutting” will be referred to as one of bookbinding processes where printed papers or blank papers are cut into the sizes of the standardized or designated specification by a cutting machine. A trimming will be referred to as a work for cutting a book after bookbinding processes, such as, saddle stitching, adhesive binding and pad binding, are completed to align cut surfaces of the book.

A “gutter” is a name of parts of a book and will be referred to as a portion adjoining to the back of a book or the side of the stitch.

A “fore-edge” will be referred to as a cut end opposite to the stitch of the trimmed book. The fore-edge will be often referred to as an edge for simplicity.

A “stitch” refers to a portion of a gutter of a book or shows the position of holes used when a book is bound. When a book is bound by thread sewing, the stitch refers to an interval between the stitches of the thread sewing.

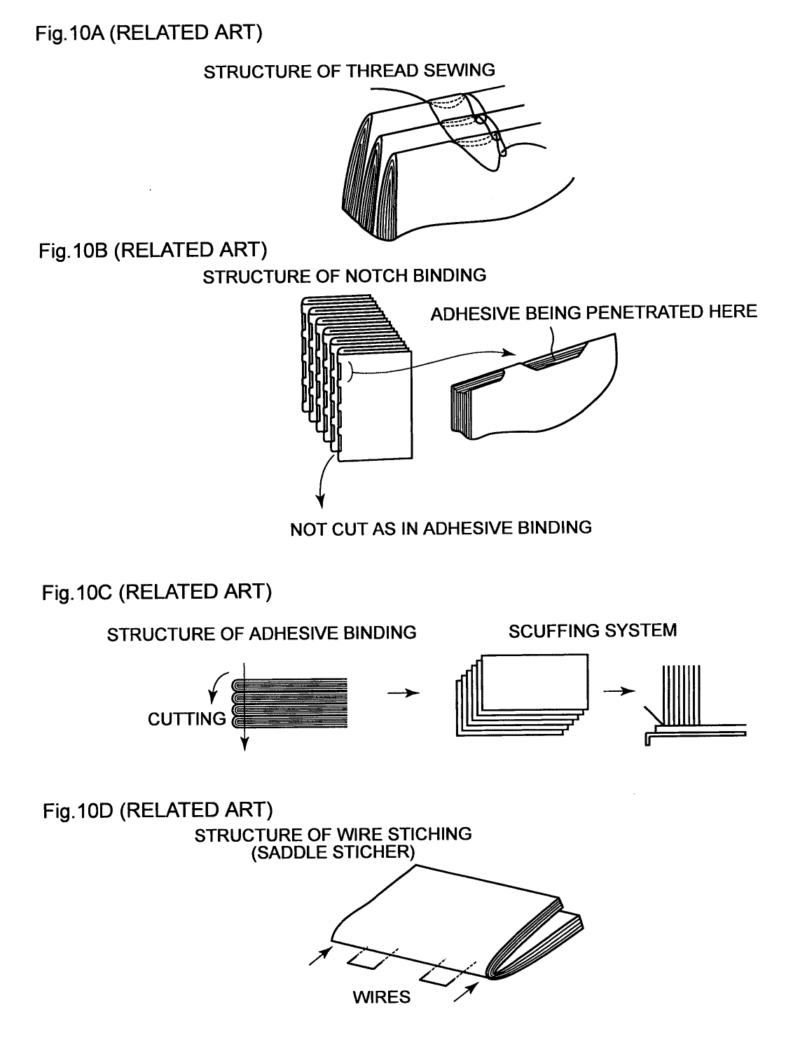

A “saddle stitching” is a method for binding gathered pulled-out folders at the center of a book by a wire (for example, stapler needle), as shown in FIG. 10D, without an adhesive. However, in the document of the present application, it should be noted that a method for binding the gathered pulled-out folders at the center of a book by using an adhesive without a wire is referred to as saddle stitching as will be described later on.

### [Content of Bookbinding]

(Target of Bookbinding)

A target “book” for bookbinding in this embodiment is a brochure 1 (not limited to the brochure) formed of totally 16 sides (sheet surfaces) of double-side printing containing a cover and a back cover in the description below unless otherwise specified. The present invention will be explained as an example of a book in which characters are written on a printing surface from left to right.

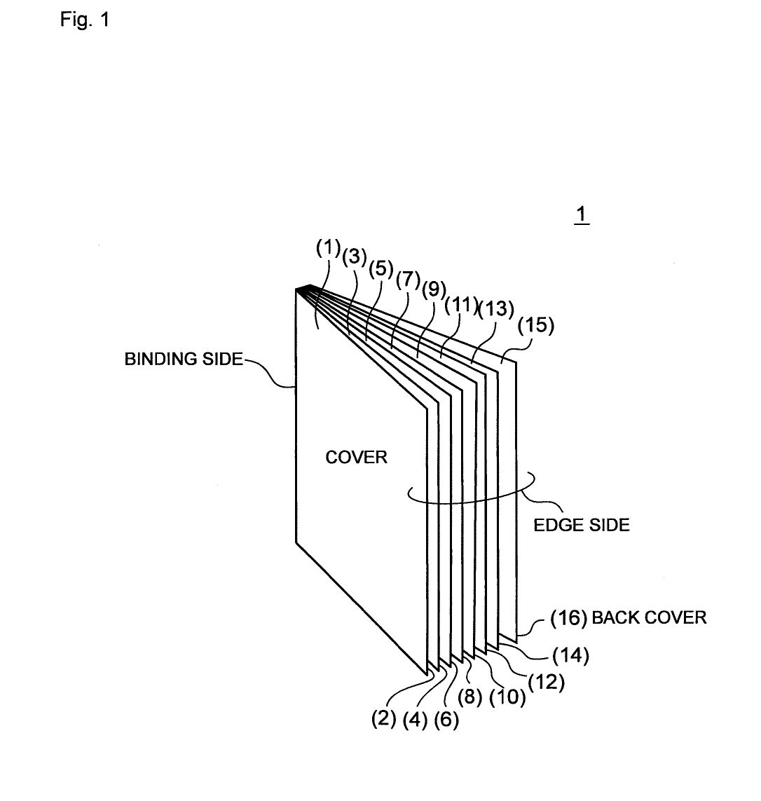

In the document of the present application, the sheet surface will be specified as follows: FIG. 1 is a perspective view of a brochure 1. A cover is assumed to be a sheet surface number (1) and a back cover is assumed to be a sheet surface number (16). Sheet surfaces directed to the same direction of the cover (1) are assumed to be sheet surface numbers (3), (5), (7), (9), (11), (13) and (15) sequentially. On the contrary, sheet surfaces directed to the same direction of the sheet surface number (16) which is the back cover are assumed to be sheet surface numbers (2), (4), (6), (8), (10), (12), (14), (16), in that order. Thus, the back of the sheet surface number (1) that is the cover is the sheet surface number (2), the back of the sheet surface number (3) is the sheet surface number (4), . . . and the back of the sheet surface number (15) is the sheet surface number (16) that is the back cover.

When the brochure 1 is paginated, it is customary that the sheet surface of the sheet surface number (3) is a first page, the sheet surface of the sheet surface number (4) is a second page, . . . the sheet surface of the sheet surface number (14) is a twelfth page of the final page and that the sheet surface number (1) serving as the cover, the back (2) of the cover, the sheet surface number (15) serving as a colophon and the sheet surface number (16) serving as the back cover are not paginated. However, when a concept of this pagination is adopted into this application, the relationship between the sheet surface numbers (1) to (16) specifying the above-described sheet surface and the page numbers becomes complex. Thus, the present invention will be explained by using only the sheet surface numbers in the explanation below.

(Bookbinding Process of Brochure)

First, in order to facilitate the understanding of the present invention, the process of how to complete the brochure 1 by the “bookbinding system using an adhesive” will be described. Roughly classifying, the bookbinding process is composed of (1) adhesive application process and (2) paper folding process. The brochure 1 bound is then trimmed by the next (3) cutting processing process and then completed.

(Adhesive Application Process)

Initially, in the adhesive application process (1), a paper on which printing contents are already printed at the sheet surface number (1) serving as the cover, the sheet surface number (16) serving as the back cover and the sheet surface numbers (2) to (15) serving as the inside paper (sheet surfaces excluding the cover and the back cover) is prepared for one sheet of paper 2 to make the brochure 1 as in FIG. 1.

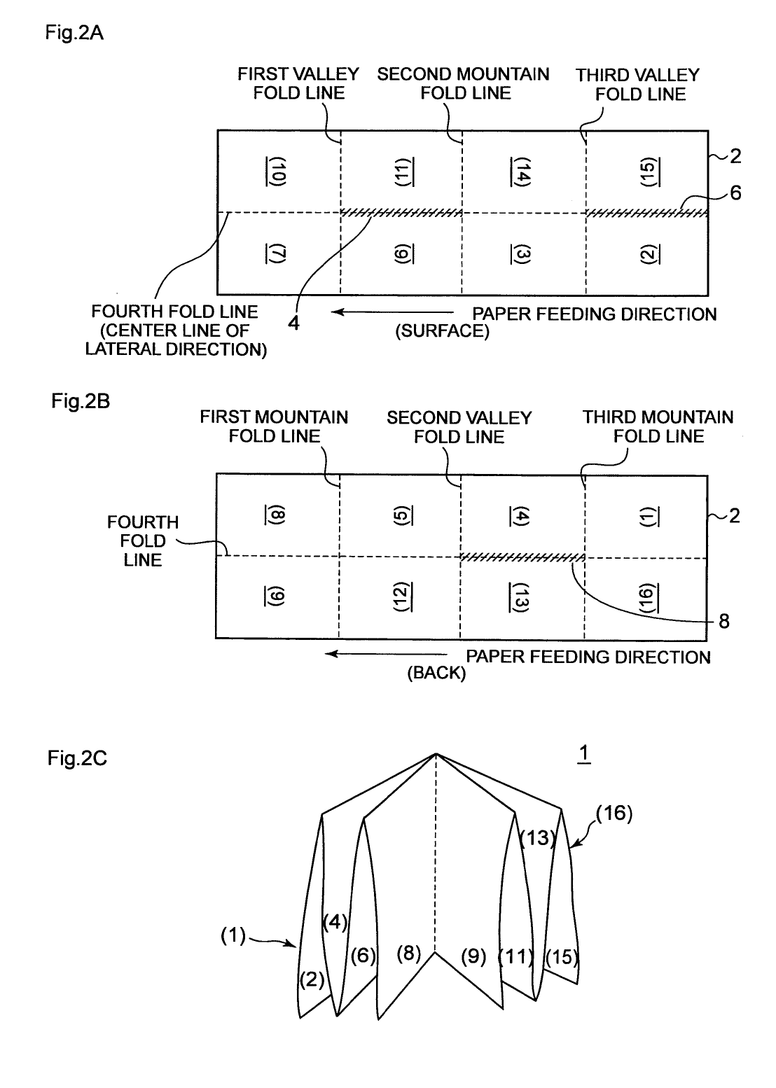

FIG. 2A shows the surface of the printed paper 2, FIG. 2B shows the back of this printed paper 2 and FIG. 2C shows the state of the brochure 1 obtained after paper folding.

As shown in FIG. 2A, the sheet surface numbers (10), (11), (14), (15) are allocated to the surface of the printed paper 2 on the upper side of the central line in the lateral direction from left to right as shown in the drawing and contents are printed thereon, respectively. Considering the direction of the characters of the sheet surface numbers, it is to be noted that the sheet surface numbers (10), (14) are set upright as seen from the left side of the drawing and that those of the sheet surface numbers (11), (15) are set upright in inverted direction. In FIG. 2A, in order to make the directions of the characters clear, lines are put beneath the sheet surface numbers. In a like manner, the sheet surface numbers (7), (6), (3), (2) are allocated on the surface of the printed paper at the lower side of the central line of the lateral direction from left to right and contents are printed thereon respectively.

FIG. 2B shows the back of the printed paper obtained when the printed paper in the state shown in FIG. 2A is rotated 180 degrees around the axis of a fourth fold line. The reverse sides of the sheet surface numbers (10), (11), (14), (15), (7), (6), (3), (2) are the sheet surface numbers (9), (12), (13), (16), (8), (5), (4), (1), respectively.

In the adhesive application process, as shown in FIG. 2A, since the sheet surface numbers (10), (7) and (11), (6) are folded at a first valley fold line, an adhesive is applied to an adhesive application area 4 located at a boundary between the sheet surface numbers (11) and (6) in order to glue both of them. In a like manner, since the sheet surface numbers (14), (3) and (15), (2) are folded at a third valley fold line, an adhesive is applied to an adhesive application area 6 located at a boundary between the sheet surface numbers (15) and (2) in order to glue both of them. In the reverse side, as shown in FIG. 2B, since the sheet surface numbers (5), (12) and (4), (13) are folded at a second valley fold line, in order to glue both of them, an adhesive is applied to an adhesive application area 8 located at a boundary between the sheet surface numbers (4) and (13).

These adhesive applications are carried out when the printed paper is moved in the paper feeding direction. It should be noted that, while the adhesive is applied to one of the sheet surfaces to glue them at the valley fold line in the above-described example, the present invention is not limited thereto. The adhesive may be applied to the other sheet surface. Alternatively, the adhesive may be applied to both of the sheet surfaces. When the adhesive is applied to the other sheet surface, the adhesive application area 6, for example, is located at the boundary between the sheet surface numbers (14) and (3). When the adhesive is applied to both of the sheet surfaces, the adhesive application area 6 is located at the boundaries between the sheet surface numbers (14), (15) and (3), (2).

Next, concrete adhesive application systems in this adhesive application process will be described. Having aimed to reliably bind the brochure without missing pages and misplaced pages, as a result of trial and error, the inventor of the present application could complete several adhesive application systems (methods). To be concrete, the following respective systems were completed as adhesive application systems (methods):

(i) line system;

(ii) dot system;

(iii) dot system using surface tension;

(iv) dot or line system for applying an adhesive after adhesive penetration perforations are formed;

(v) dot or line system for applying an adhesive from both of the surface and back after adhesive penetration perforations are formed;

(vi) dot or line system for applying an adhesive from both of the surface and back and separately controlling adhesive application pressures on the surface and back after adhesive penetration perforations are formed;

(vii) dot or line system for applying an adhesive from both of the surface and back and separately controlling adhesive application pressures on the surface and back and controlling a quantity of an adhesive in response to glued portions, after adhesive penetration perforations are formed.

Details of the respective adhesive application systems will be described as follows:

Line System (i)

An adhesive is applied to the adhesive application areas 4, 6 shown in FIG. 2A and the adhesive application area 8 shown in FIG. 2B in a line along the fourth fold line. Specifically, the adhesive is applied to the adhesive application areas 4, 6 shown in FIG. 2A from the surface of the sheet and to the adhesive application area 8 shown in FIG. 2B from the back of the sheet on a line, respectively.

Dot System Adhesive Application System (ii)

The adhesive is applied to the adhesive application areas 4, 6 shown in FIG. 2A and the adhesive is applied to the adhesive application area 8 shown in FIG. 2B not in a line but in dots or in a broken line (hereinafter, representatively called as “in dots”) formed at a constant interval. Specifically, the adhesive is applied to the adhesive application areas 4, 6 shown in FIG. 2A from the surface of the sheet. The adhesive is applied to the adhesive application area 8 shown in FIG. 2B from the back of the sheet in dots. Each interval between the adjacent dots is approximately 2 mm, for example, when a book or the brochure shown in FIG. 1 is made.

Dot System Using Surface Tension (iii)

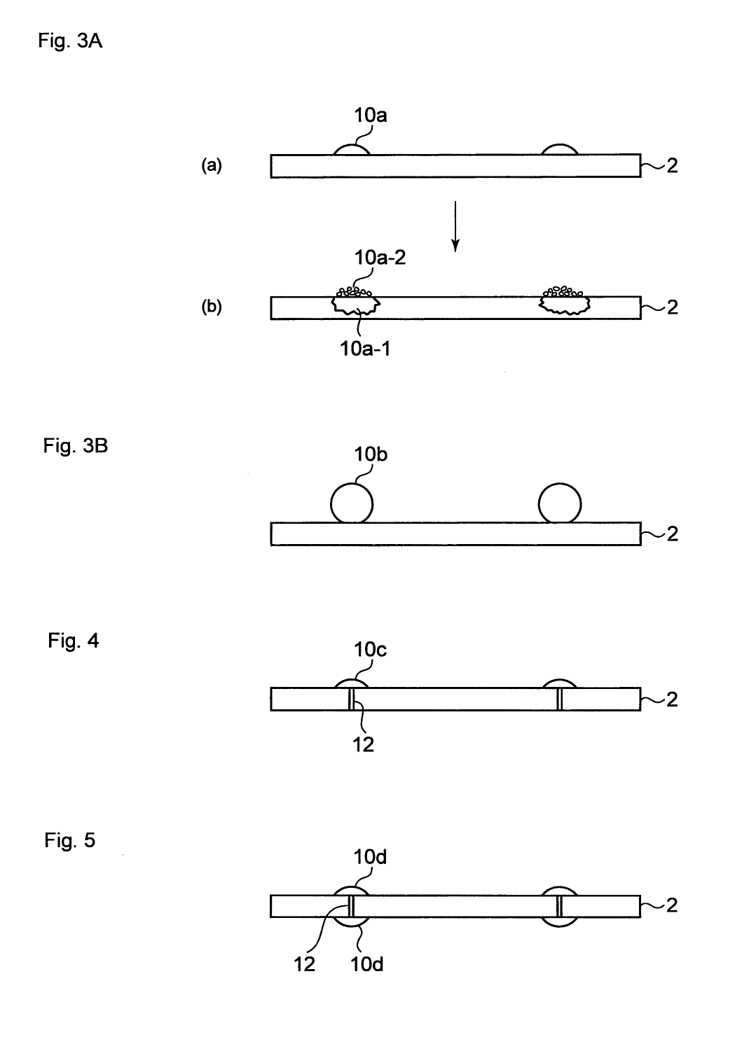

When bookbinding was carried out by using the above-described dot system (ii), a phenomenon in which bond strength was slightly weak against force to separate the book was discovered. Having investigated this cause, the inventor of the present application has found that, an adhesive 10a applied to the printed paper 2 as shown in FIG. 3A (b), has a solvent (liquid component) 10a-1 penetrated into the inside of the paper and a solute (solid component) 10a-2 left on the surface of the paper so that the adhesive 10a is partly penetrated into the paper, as shown in FIG. 3B(b), before the next paper folding process. It is to be understood that, in order to overcome this phenomenon, it is important to prevent the solvent (liquid component) 10a-1 and the solute (solid component) 10a-2 from being separated from each other until the paper folding process.

To this end, the inventor of the present application has developed a dot system using surface tension. As shown in FIG. 3B, the applied adhesive 10b is prevented from being separated into the solvent (liquid component) and the solute (solid component) by using surface tension until the paper folding process. Specifically, the adhesive 10b can be kept spherical by using surface tension until the paper folding process.

Since necessary conditions for realizing the dot system using surface tension are affected by various factors such as an adhesive application apparatus, kind of adhesives, component, viscosity, quantity of adhesive application, adhesive application speed, kind of paper, surface condition of paper, temperature in the work, etc., it is very difficult to determine necessary conditions quantitatively. Also, even when one working condition is determined and this working condition is claimed, a large number of other working conditions can be set and hence such claimed working condition becomes meaningless. Necessary conditions of the working conditions can be quantitatively determined by a plurality of trials for changing viscosity, quantity of adhesive application, adhesive application speed, temperature in the work and the like at the stage in which adhesive application apparatus, kind of adhesive, component, kind of paper, surface state of paper and the like are determined.

The feature of the present invention is to keep the adhesive 10b spherical as much as possible by using surface tension until the paper folding process of the next process so that the adhesive 10b can be prevented from being separated into the solvent (liquid component) and the solute (solid component).

Dot or Line System for Applying Adhesive after Adhesive Penetration Perforations are Formed (iv)

According to the above-described dot system using the surface tension (iii), it was possible to almost reliably prevent the adhesive 10b from being separated into the solvent (liquid component) and the solute (solid component) as much as possible until the paper folding process.

However, troublesome works for determining working conditions by a plurality of trials each time parameters such as an adhesive application apparatus and the kind of adhesive are varied are left unsolved.

Therefore, the inventor of the present application has discovered that the solvent (liquid component) and the solute (solid component) are not separated and held on the surface of paper and within perforations by carrying out adhesive application after an adhesive penetration perforations 12 are formed in advance on the adhesive application area of the printed paper 2. As shown in FIG. 4, the perforations 12 are formed on the paper 2 and the adhesive 10c is applied to the paper along the perforations 12.

A process for forming the adhesive penetration perforations 12 on the adhesive application area of the paper 2 is carried out by using an industrial sewing machine and the like. In this case, it is preferable that the adhesive penetration perforation 12 should be formed not only on the adhesive application area but also on an area which is to be opposed to the adhesive application area upon paper folding. Accordingly, when a lot of books are bound by bookbinding, the adhesive penetration perforations 12 are formed along the fourth fold line. It should be noted that the adhesive penetration perforation 12 should preferably be not formed on the boundary portion between the sheet surface numbers (15) and (2) shown in FIG. 2A. The reason for this is that this portion becomes the outermost layer of the brochure, so that, when the adhesive penetration perforation is formed on this portion, the adhesive is oozed out from this adhesive penetration perforation to damage the external appearance of the brochure.

A shape of the adhesive penetration perforation 12 is not limited to circle but it may be ellipse, square, hexagon, so-called broken-line like gap and so on. The reason for this is that it is sufficient that the liquid adhesive 10c can be penetrated into the inside of the paper 2. It should be noted that the adhesive application may be carried out by using either the dot system or the line system.

Dot or Line System for Applying Adhesive from Both of Surface and Back after Adhesive Penetration Perforation was Formed (v)

The inventor of the present application has made various examinations in order to penetrate the adhesive into the perforations of the paper more reliably in the dot or line system for applying adhesive after adhesive penetration perforation is formed (vi).

As a result of forming the perforation 12 on the paper 2, it was possible to apply the adhesive not only to the adhesive applications areas shown in FIGS. 2A and 2B but also to the paper from the opposite side of the paper of these application areas. For example, it was possible to apply the adhesive to the perforation 12 on the application area 4 located between the sheet numbers (11) and (6) in FIG. 2A from the back side (boundary portion between the sheet numbers (5) and (12) in FIG. 2B) of this application area.

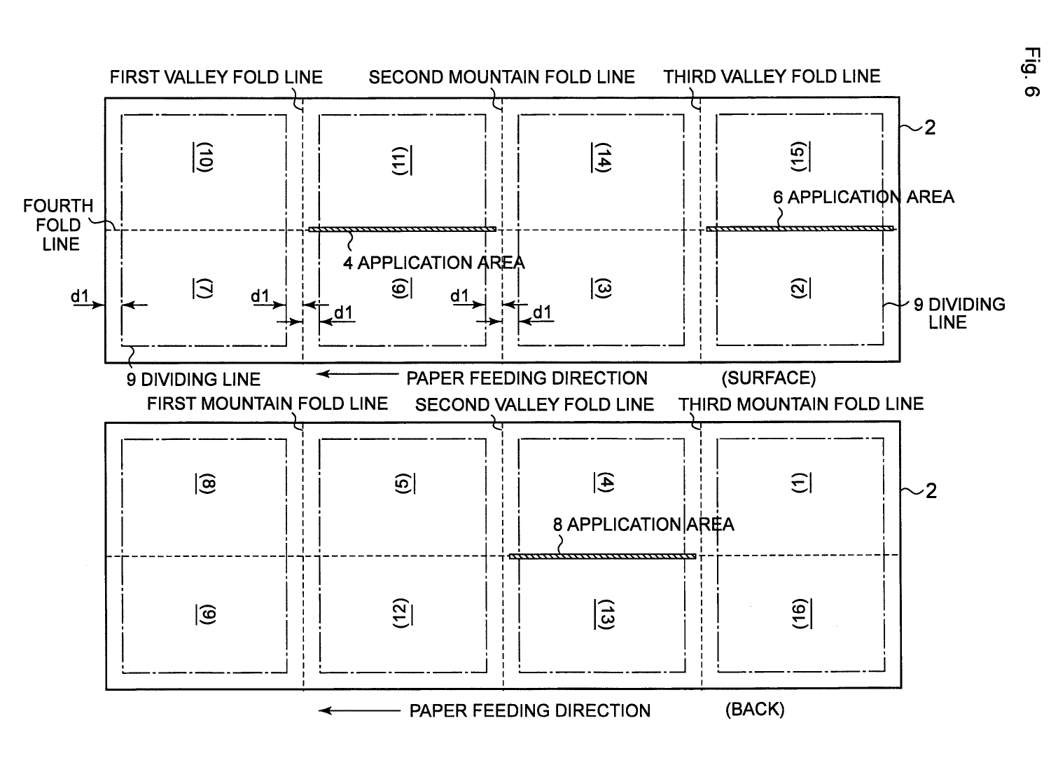

As a result, according to the dot or line system for applying the adhesive from both of the surface and the back, the adhesive 10d is applied to the paper from both of the surface and the back of the paper 2. As shown in FIG. 5, the adhesive penetration perforation 12 is formed on the paper 2 and the adhesive 10d is applied to the paper from both of the surface and the back of the paper 2 along the perforations 12.

According to this system, in the adhesive application process, when the printed paper 2 is moved in the horizontal direction, guns exclusively used to carry out adhesive application are placed at both of the surface and back of the paper to inject the adhesive 10d into the paper along a line of the perforations 12. It should be noted that adhesive application may be carried out by adopting any of the dot system and the line system.

Dot or Line System for Applying Adhesive from Both of the Surface and the Back and Separately Controlling Adhesive Application Pressures at the Surface and the Back after the Adhesive Penetration Perforation is Formed (vi)

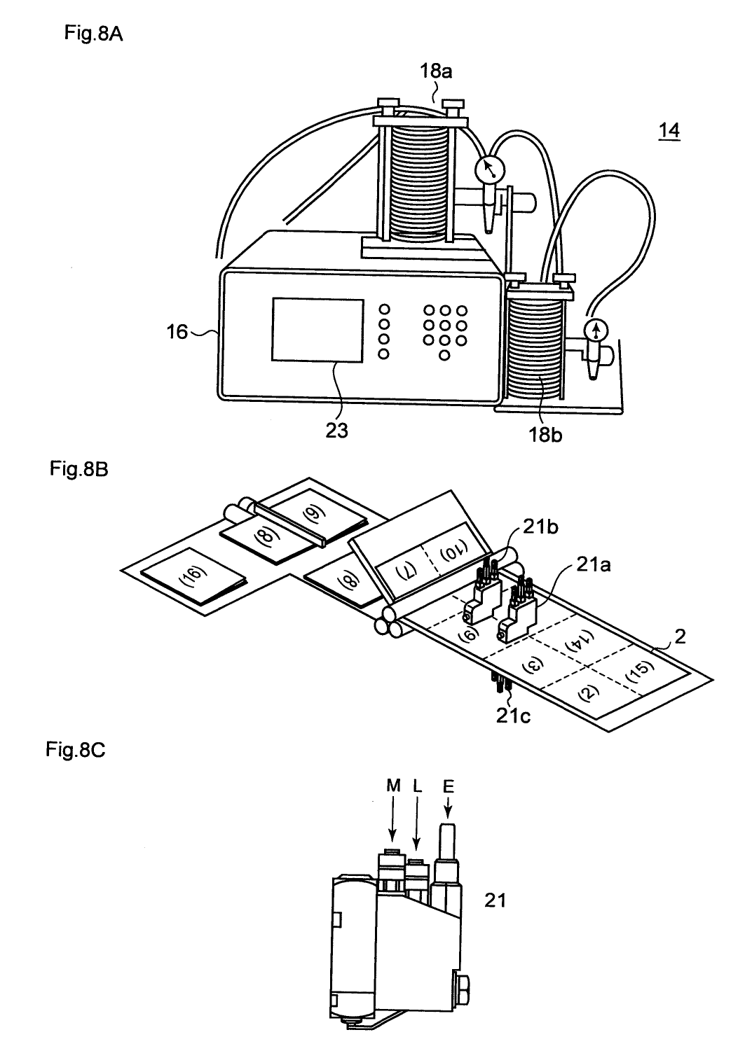

As will be described later on in relation to FIGS. 8A to 8C, the inventor of the present application has discovered that, when an adhesive was supplied to the application gun for the surface of the paper and the application gun for the back of the paper from a single adhesive pressure tank, a variation occurred in an adhesive pressure (as a result, a quantity of applied adhesive) so that it was not always possible to completely control an adhesive application pressure. As compared with a pressure of an application gun for applying an adhesive to the surface of paper, a pressure of an application gun for applying an adhesive to the back tends to be low. In order to overcome a variation of a quantity of an applied adhesive, the inventor of the present invention respectively prepared pressure tanks for the surface application gun and the back application gun such that adhesive application pressures (quantities of adhesives) can be controlled independently. It should be noted that the number of pressure tanks is not limited to two. Each application gun may have one pressure tank or application guns may be grouped and each group of application guns may have one pressure tank. It should be noted that an adhesive may be applied by adopting either the dot system or the line system.

Dot or Line System for Applying Adhesive from Both of the Surface and the Back Separately and Controlling Quantities of Adhesive in Response to Glued Portions after Adhesive Penetration Perforations are Formed (vii)

When the paper is folded along the fourth fold line in the paper folding process, an outer paper portion has a larger radius of curvature and an inner paper portion has a small radius of curvature, as the outer paper portion is put on the inner paper portion. The inventor of the present application discovered that a large stress is applied to the outer paper portion along the fourth fold line portion so that the applied adhesive tended to be oozed partly. As a result, as the thickness of paper is increased, this bond strength tends to be weak and hence the neighboring paper portions may become easy to be separated. Further, as described in the above-described system (iv), when the adhesive penetration perforation 12 is not formed on the adhesive application area 6 (i.e. boundary portion between the sheet surface numbers (15) and (2) shown in FIG. 2A), bond strength is weakened as compared with other areas.

To avoid this disadvantage, as compared with quantities of adhesives applied to the application areas 4, 8, a quantity of an adhesive applied to the application area 6 is increased. However, at this stage, it is difficult to vary adhesive application pressures for every application area relative to the paper 2 transported at high speed. Accordingly, as will be shown in FIG. 8B later on, the application gun of the surface side is composed of two guns, i.e., a gun with a relatively large nozzle diameter and a gun with a relatively small nozzle diameter. When an adhesive is applied to the application area 6, a quantity of an adhesive is increased by using the application gun with a relatively large nozzle diameter.

However, a quantity of applied adhesive is not limited to two stages. When a paper is folded along the fourth fold line, a quantity of adhesive applied to the paper portion located a little in the outside is identical to or larger than that of an adhesive applied to the paper portion located at little in the inside. In order to realize this control, a system to use an application gun is not limited to the above-described systems. There can be prepared application guns the number of which can satisfy a necessary quantity of adhesive. Also, if it is possible to obtain an apparatus in which an adhesive application pressure can be varied at every application area relative to the paper 2 transported at high speed, then a plurality of application guns need not be prepared for one side. It should be noted that an adhesive may be applied by using either the dot system or the line system.

Which one of the above-described adhesive application systems (i) to (vii) is to be adopted is determined depending on a target book, the number of papers composing a book, a sheet surface and a state of its surface, a kind of adhesive and so on.

Further, a finishing line, adhesive application areas and so on in this adhesive application process will be described. FIG. 6 is an enlarged view of FIGS. 2A and 2B. A line that is to be cut in the final cutting and processing process is shown as a finishing line 9. The finishing line 9 is located in the inside from the end face of the sheet surface and the fold line of each longitudinal direction by a length d1 (e.g. about 5 mm). Specifically, after a paper is cut at the finishing line, the adhesive can be immediately applied from the finishing line in the normal state. As a result, it is possible to avoid an influence of a change (scattering) of a quantity of an adhesive applied to the end portion of the application area, an influence exerted when a paper is curved upon paper folding and the like. To be concrete, it is possible to remove a tendency such that bond strength is weak at the finished end portion so that paper portions each can be detached with ease. Thus, the paper portions can be glued uniformly.

Further, it is preferable that no printing is made on the fourth fold line at which the application areas 4, 6, 8 shown in FIG. 6 are located over an area having constant width (e.g. 1 to 2 mm) so that the area should be left as white grounds. The reason for this is that when printed, the surface is smoothened by a printing ink so that bond strength of adhesive is weakened.

(Paper Folding Process)

FIG. 2A shows fold lines for indicating the sequential order in which a paper is folded along a first valley fold line, a second mountain fold line, a third valley fold line and a fourth fold line (paper is folded so as to bring the right side of the sheet surface numbers (1), (16) up). FIG. 2B also shows a first mountain fold line, a second valley fold line, a third mountain fold line and the fourth fold line in response to these fold lines.

In the paper folding process, the printed paper 2 in which the adhesive 10 is applied to each adhesive application area are folded in the sequential order displayed by these fold lines. The printed paper 2 is folded in the longitudinal direction along the first mountain fold line, the second valley fold line and the third mountain fold line and then compression-bonded by a roller along the adhesive application area (i.e. fourth fold line). After that, the printed paper 2 is folded in the lateral direction along the fourth fold line. FIG. 2C shows the state in which the printed paper 2 is folded in this sequential order. Since an adhesive is a relatively quick-drying adhesive, this state is held and the bookbinding process is ended.

(Cutting and Processing Process)

Next, the cutting and processing process (3) will be described. In general, cutting processing includes cutting, punch-hole process, die-cutting process and so on. The cutting can cut a fore-edge, a head and foot and the like by bleed off cutting. The punch-hole process can form circular holes, elliptical holes and holes of other shapes in the inside of the sheet surface or the end face of the brochure 1. The die-cutting process can cut the fore-edge, the head and foot and the like in the form of arbitrary shapes and can form openings of arbitrary shapes in the inside of the sheet surface.

In the brochure 1 according to the embodiment of the present invention, when a brochure of a standard rectangular shape is formed, the fore-edge and the head and foot are cut by bleed off cutting. Further, when a brochure 1 of a special shape is formed, the fore-edge, the head and foot and the like of the brochure 1 are cut in desired shapes and openings of desired shapes are formed in the inside of the sheet surface by die-cutting process.

### [Bookbinding and Cutting System]

Next, the inventor of the present application was able to realize an embodiment of the bookbinding process and the cutting processing process of the above-mentioned brochure 1. The embodiment of the bookbinding and cutting system that were already realized will be described as an embodiment of “bookbinding system using adhesive”.

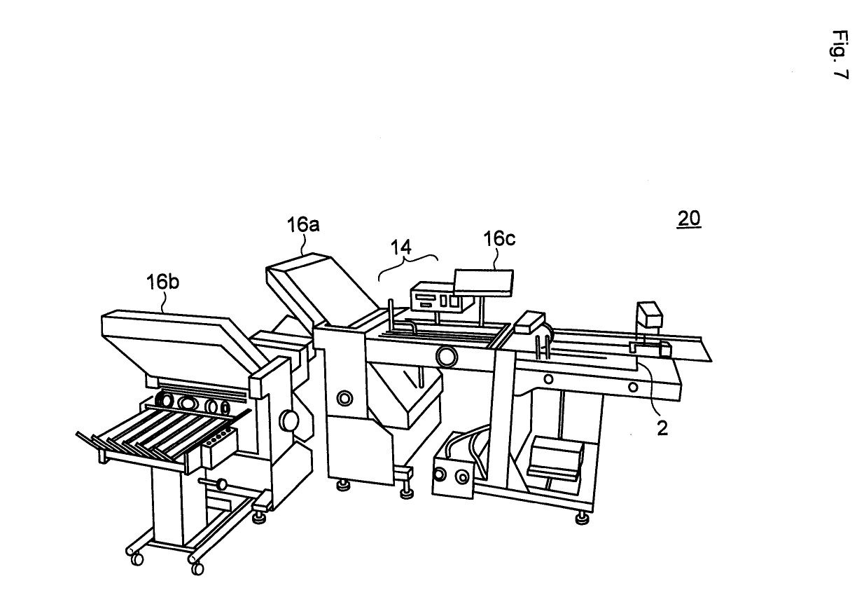

FIG. 7 is a diagram showing the entire bookbinding and cutting system using adhesive according to the embodiment of the present invention. Although a subject matter of the embodiment of the present invention is “bookbinding system using adhesive”, the present invention will be described as the bookbinding and cutting system using adhesive, as a cutting system can be combined with the booking system as a postprocess, so that attractive brochures can be completed. It should be noted that, at the present stage, an adhesive penetration perforation forming apparatus and a cutting apparatus are not incorporated in this system. Holes are formed by the adhesive penetration perforation forming apparatus prior to treatments carried out by this system, and cutting is carried out by the cutting apparatus after treatments were carried out by this system. It is intended to incorporate these processes into a series of bookbinding and cutting system sequentially.

This bookbinding and cutting system 20 includes an adhesive application system 14, automatic paper folding machines 16a, 16b, 16c and a cutting processing machine (not shown) fundamentally.

(Adhesive Application System)

A bookbinding technology for applying an adhesive on a book, like the brochure 1, along a fold line, as shown in FIG. 1, in a line or dots has not existed heretofore. Accordingly, through trial and error, the inventor of the present application has decided working conditions by using an adhesive application system designed to be driven in a high speed folding machine for corrugated boards.

The adhesive application system 14 will be described with reference to FIGS. 8A, 8B and 8C. The adhesive application system 14 mainly includes a controller 16, adhesive accumulating pressure tanks 18a, 18b and application guns 21a, 21b and 21c. The adhesive 10 used herein is generally referred to as cold glue.

(Controller)

FIG. 8a is a diagram showing the controller 16 and the cold glue pressure tanks 18a, 18b. A controller, which is available as a model number XT-E4 manufactured by Baumer hhs GMBH in Germany (this controller is commercially available in Japan through K's company in Osaka), is used as the controller 16 of the adhesive application system 20 but this controller is not limited to the above-mentioned one. Similarly, a pressure tank model number KDB-01 is used as the pressure tank for cold glue. These controller and pressure tank were designed and developed for a high speed folding machine for corrugated boards. The inventor of the present application diverted this apparatus for bookbinding.

This controller 16 may function as a glue application system driving graphic interface which is able to operate a program on a touch screen 23 of the controller and is able to control 16 dots/line application guns 21 manufactured by Baumer hhs GMBH at maximum. The controller 16 has an encoder resolution of 1 mm/pulse, so that glue dot/line application patterns can be created on an application area having a maximum length of 4000 mm for each application gun. Further, the controller 16 is able to memorize programs by which glue dot/line application patterns of 999 kinds can be executed.

The pressure tanks 18a, 18b include tanks having capacities of 0.75 liters and a maximum deliver pressure of 2 bars from the gun 21. There are two pressure tanks 18a, 18b, because the pressure tank 18a is provided for use with the guns 21a, 21b for applying an adhesive from the surface side of paper and the pressure tank 18b is provided for use with the gun 21c for applying an adhesive from the back side of paper. Specifically, the inventor of the present application has judged that bookbinding can be made more reliable by separately controlling adhesive deliver pressures of the surface-side guns 21a, 21b and the back-side gun 21c.

Further, the two guns 21a and 21b are provide on the surface side, because the gun 21a has a relatively large nozzle diameter and the gun 21b has a relatively small nozzle diameter so that quantities of applied adhesive can be varied at every adhesive application area.

(Application Process)

As shown in FIG. 8B, the adhesive 10 is applied to the printed paper 2 by the adhesive guns 21 (21a, 21b, 21c) before it is entered into the paper folding machines 16a, 16b. The paper 2 to which the adhesive 10 was applied is sequentially folded at a first valley fold line, a second mountain fold line and a third valley fold line in the paper folding process by the paper folding machine 16a. Further, the paper is folded at a fourth fold line by using the paper folding machine 16b and bookbinding is completed.

(Application Gun)

FIG. 8C shows an example of the application gun 21 used herein. A cold glue gun available as a model number VD-400S manufactured by Baumer hhs GMBH in Germany (this gun is commercially available in Japan through K□fs company in Osaka) can be used as such application gun 21, for example. A control electric signal input E, a glue (adhesive) M and an air L are introduced into this gun 20 to apply the adhesive 10 to the paper 2 under set conditions.

(Adhesive)

When the adhesive 10 was determined, the inventor of the present application paid sufficient attentions to safety in order to use it for brochures attached to foods and brochures with toys for little children. In practice, manufacturers for adhesives tend not to disclose accurate compositions of adhesives from a viewpoint of an industrial secret. Accordingly, it should be noted that, in most cases, users are able to obtain only material safety data sheets from manufacturers of adhesives.

To be concrete, a “denatured acrylic vinyl acetate copolymer resin water emulsion (chemical substance name)” adhesive of which main component is acrylic acetate copolymer resin, for example, may be used as the adhesive. Adhesives manufactured by NICHIEI KAKOH CO., LTD., in Higashi-Osaka-shi, and commercially available under the trade names of “LIFE BOND AV-173L, LIFE BOND AV-173LL modified, and LIFE BOND AV-175L” may be used as such adhesives, for example. According to product properties tables provided by the manufacturer (dated on Mar. 15, 2004, Mar. 15, 2004 and Dec. 15, 2004, respectively), such adhesives have no “chemical substances restricted by Laws” with respect to “composition/component information” and they do not have the “most significant hazard: any specially mentioned hazard” with respect to classification of hazard.

Otherwise, “synthetic resin adhesive” manufactured by EUKALIN GMBH under the product number EUKALIN 6271L, for example, may also be used as the adhesive. According to a material safety data sheet dated Jun. 30, 2006, provided by this manufacturer, it clearly states “this adhesive can be used to manufacture food packages according to the Laws in Germany”.

(Automatic Paper Folding Machine)

A variety of automatic paper folding machines 16 can be used for paper folding. As an automatic paper folding machine in the trial stages, the inventor of the present application used a high speed automatic paper folding machine of which model number is “multimaster CAS 52-B with SetMATIC”. This “multimaster CAS 52-B with SetMATIC” is manufactured and distributed by Mathias Bauerle GMBH at St Georgen in Germany and it is commercially available in Japan through CORRENS CORPORATION at Chiyoda-ku, Tokyo.

This high speed automatic paper folding machine 16 is a computer-controlled paper folding machine, thoroughly programmed for standard paper folding and can also be programmed for other paper folding. This high speed automatic paper folding machine is able to memorize paper folding jobs of 60 kinds and it is suitable for repetitive paper folding. The display 16c is of an interactive type. When a user only presses buttons, a control system sets an important setting. Further, the user is able to carry out automatic folding roller pressure adjustment, automatic alignment rail adjustment, automatic paper discharge wheel position adjustment, automatic setting of previously-memorized working data and so on.

With respect to main performance, a paper size is 52×85 cm at maximum and 10×12 cm at minimum for a buckle folding unit. In a buckle/knife folding system, a paper size is 52×72 cm at maximum and 15×30 cm at minimum. A folding length is 35 cm at minimum for the buckle folding unit and 75 cm at minimum for a knife folding unit KL. A paper folding speed is 200 m/minute.

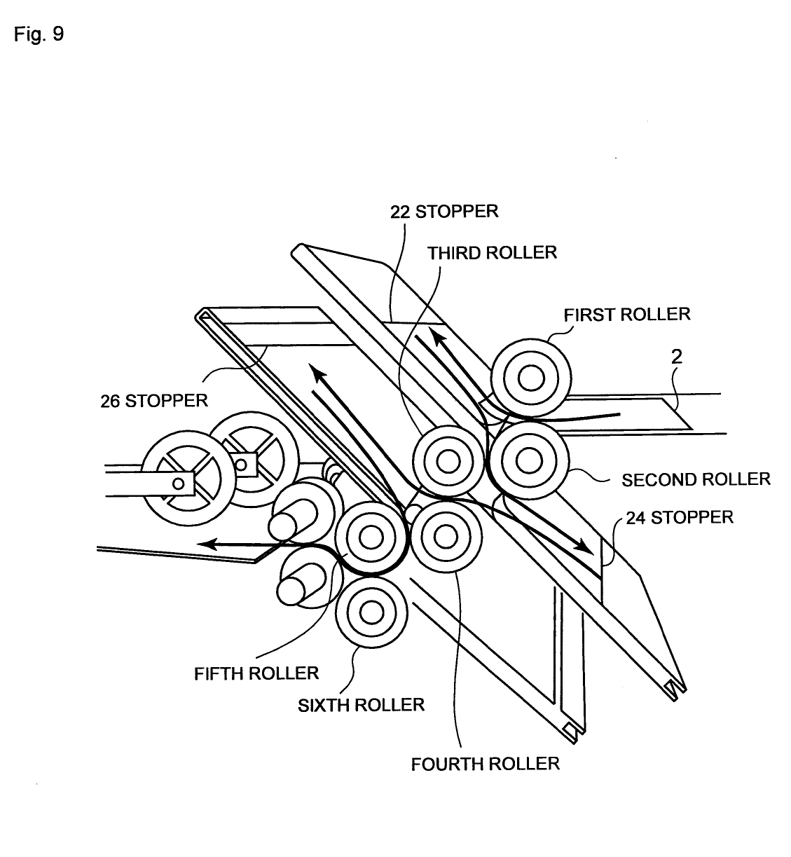

FIG. 9 is a diagram to explain a principle of the portion of the longitudinal direction paper folding machine 16a of this high speed automatic paper folding machine. A paper is folded in the longitudinal direction as follows: A paper is advanced by a first roller (rotated in a counter-clockwise direction) and a second roller (rotated in a clockwise direction) and supplied to a stopper 22. Next, the paper is advanced by the second roller (rotated in the counter-clockwise direction) and a third roller (rotated in the clockwise direction), folded at the first valley fold line and supplied to a stopper 24. Next, the paper is advanced by the third roller (rotated in the clockwise direction) and a fourth roller (rotated in the counter-clockwise direction), folded at the second mountain fold line and supplied to a stopper 26. Next, the paper is advanced by the fourth roller (rotated in the counter-clockwise direction), a fifth roller (rotated in the clockwise direction) and a sixth roller (rotated in the counter-clockwise direction), folded by the third valley fold line and then advanced. At this point, the paper is compression-bonded at bonding portions along the fourth fold line by a roller (not shown).

Thereafter, the paper is folded in the lateral direction along the fourth fold line by a lateral direction paper folding machine 16b. However, folding is not limited to the above-mentioned folding and it is acknowledged that various kinds of paper folding machines suitable for bookbinding can be used. As set forth above, the paper folding process of the brochure 1 is ended.

(Cutting and Processing Machine)

A cutting machine □model number “BS MULTI 450/*750” manufactured by BOCHSLER GRAFISCHE MASCHINEN GMBH in Germany may be used as a cutting machine. According to this cutting machine, a single cutting machine is able to carry out punch-hole and die-cutting processing. It should be noted that, at this point, this cutting machine performs cutting separately after bookbinding so that this cutting machine is not yet incorporated into a series of systems shown in FIG. 7.

### Advantage and Effect of the Embodiment

According to the embodiment of the present invention, the following advantages and effects can be achieved.

(1) Bookbinding without stapler needle can be made;

(2) A reader can be prevented from being injured at a finger by a sharp tip end of a bound stapler needle during reading;

(3) No stapler needle remains when a book is dissolved by a suitable solvent for reuse (recycle);

(4) No stapler needle remains when a book is burned after having been used;

(5) No stapler needle is detached from an explanatory leaflet, so that it is possible to avoid the occurrence of accident such that a user swallows the detached stapler needle inadvertently when a book is an explanatory leaflet or the like attached to drinks, foods and so on; and

(6) No little child or child swallows a stapler needle inadvertently in the case of a picture book exclusively used by little children and children or a brochure such as an explanatory leaflet for toys.

### SUMMARY

While the embodiment of the bookbinding system using the adhesive according to the present invention is described, this embodiment is merely one example and hence the present invention is not limited thereto. The number of pages (number of sheet surface numbers) of a target book (brochure) may be arbitrary. Further, the present invention is not limited to the apparatuses or materials described in the embodiment and the like. These used apparatus and materials and the like have been described in detail, so that those skilled in the art may easily check the used apparatus and material later on. These used apparatus, materials and so on are merely examples and hence they are not limited to the present invention in any way.

Addition, deletion, modification, improvement and the like made on this embodiment by those skilled in the art are within the scope of the present invention. A technical scope of the present invention should be determined by descriptions of the attached scope of claims.

1-15. (canceled)

16. A bookbinding apparatus using an adhesive comprising:
an adhesive application apparatus;
a paper folding apparatus continuously connected to said adhesive application apparatus; and
a conveying apparatus for conveying at high speed a printed paper, with stitch-like adhesive penetration perforations formed at portions to which an adhesive is to be applied, to said adhesive application apparatus and said paper folding apparatus,
said adhesive application apparatus including a plurality of adhesive application guns, each gun including a control apparatus, located near both surfaces of said conveyed printed paper, said adhesive application guns delivering an adhesive to said adhesive penetration perforations formed in the paper feeding direction to apply said adhesive to said printed paper;
said paper folding apparatus including:
a paper folding apparatus for carrying out valley folding and mounting folding on said printed paper in the vertical direction relative to the paper feeding direction from the beginning the number of predetermined times alternately and repeatedly;
a roller apparatus for compression-bonding bonded portions along paper fold lines; and
a paper folding apparatus for folding said printed papers into two in the paper feeding direction along said adhesive penetration perforations.

17. A bookbinding apparatus using an adhesive according to claim 16,
wherein said adhesive application gun allows a quantity of applied adhesive to be varied at every adhesive application area.

18. A bookbinding apparatus using an adhesive according to claim 17,
wherein said adhesive application gun increases a quantity of an adhesive applied to an outer adhesive application area as compared with a quantity of an adhesive applied to an inner adhesive application area, when the printed paper is folded.

19. A bookbinding apparatus using an adhesive according to claim 16,
wherein said adhesive application gun applies an adhesive in a line on said adhesive penetration perforations.

20. A bookbinding apparatus using an adhesive according to claim 16,
wherein said adhesive application gun applies an adhesive in dots spaced apart at a constant interval on said adhesive penetration perforations.

21. A bookbinding apparatus using an adhesive according to claim 16,
wherein said printed paper has the adhesive application areas of white backgrounds.

22. A bookbinding apparatus using an adhesive according to claim 16,
wherein said adhesive is guaranteed for safety by a product safety data sheet for use with brochures attached to foods or toys for little child.

23. A bookbinding and cutting apparatus comprising:
an apparatus for forming adhesive penetration perforations on a printed paper;
a bookbinding apparatus using an adhesive comprising;
an adhesive application apparatus;
a paper folding apparatus continuously connected to said adhesive application apparatus; and
a conveying apparatus for conveying at high speed a printed paper, with stitch-like adhesive penetration perforations formed at portions to which an adhesive is to be applied, to said adhesive application apparatus and said paper folding apparatus,
said adhesive application apparatus including a plurality of adhesive application guns, each gun including a control apparatus, located near both surfaces of said conveyed printed paper, said adhesive application guns delivering an adhesive to said adhesive penetration perforations formed in the paper feeding direction to apply said adhesive to said printed paper;
said paper folding apparatus including:
a paper folding apparatus for carrying out valley folding and mounting folding on said printed paper in the vertical direction relative to the paper feeding direction from the beginning the number of predetermined times alternately and repeatedly;
a roller apparatus for compression-bonding bonded portions along paper fold lines; and
a paper folding apparatus for folding said printed papers into two in the paper feeding direction along said adhesive penetration perforations; and
a cutting apparatus for cutting and processing bound printed paper.

24. A bookbinding apparatus using an adhesive according to claim 23,
wherein said adhesive application gun allows a quantity of applied adhesive to be varied at every adhesive application area.

25. A bookbinding and cutting apparatus according to claim 24,
wherein said adhesive application gun increases a quantity of an adhesive applied to an outer adhesive application area as compared with a quantity of an adhesive applied to an inner adhesive application area, when the printed paper is folded.

26. A bookbinding and cutting apparatus according to claim 23,
wherein said adhesive application gun applies an adhesive in a line on said adhesive penetration perforations.

27. A bookbinding and cutting apparatus according to claim 23,
wherein said adhesive application gun applies an adhesive in dots spaced apart at a constant interval on said adhesive penetration perforations.

28. A bookbinding and cutting apparatus according to claim 23,
wherein said printed paper has the adhesive application areas of white backgrounds.

29. A bookbinding and cutting apparatus according to claim 23,
wherein said adhesive is guaranteed for safety by a product safety data sheet for use with brochures attached to foods or toys for little child.
